(19) United States
(12) Patent Application Publication
(10) Pub. No.: US 2012/0050319 A1
(43) Pub. Date: Mar. 1, 2012

(54) IMAGE PROCESSING APPARATUS AND METHOD

(75) Inventor: Hiroaki Yoshino, Yokohama-shi (JP)

(73) Assignee: CANON KABUSHIKI KAISHA, Tokyo (JP)

(21) Appl. No.: 13/206,726

(22) Filed: Aug. 10, 2011

(30) Foreign Application Priority Data
Aug. 25, 2010 (JP) 2010-188657

(51) Int. Cl. G09G 5/00

(52) U.S. Cl. 345/629

(57) ABSTRACT

An image processing apparatus to combine a plurality of images, includes an acquisition unit that acquires a combined region when the images are combined, an image processing unit that performs image processing on at least one of the plurality of images, and a limitation unit that limits the image processing performed on the combined region by the image processing unit.

### BACKGROUND OF THE INVENTION

1. Field of the Invention

The present invention relates to an image processing apparatus and method to combine a plurality of images.

2. Description of the Related Art

In a medical diagnosis using a radiographic image, an image of a subject of the size that cannot be taken in one radiation image may be needed. In such a case, a radiation image is taken for each portion of the subject and a plurality of obtained radiographic images is combining to obtain one radiographic image. However, for appropriate combination of the plurality of radiographic images, manual operations by the user alone may not be enough. Thus, conventionally techniques to guide combination processing by performing recognition processing of a combined region on the plurality of radiation images have been proposed.

For example, Japanese Patent Application Laid-Open No. 2002-94772 discusses a technology that performs recognition processing of a combined region on a plurality of radiation images and based on the recognized combined region, attaches marks to guide combination processing to the radiation images.

Outside the field of medical diagnosis using a radiographic image, techniques such as guiding generation of a panorama image based on a recognition processing result obtained by performing recognition processing on a plurality of photographed images have also being proposed.

To guide combination processing of a plurality of images appropriately, it is necessary to perform recognition processing of combined regions with desired precision. However, mask processing, gradation adjustments, or cutout processing of a partial region for each of the plurality of images may be performed as preprocessing of the combination processing. If such preprocessing is performed, it may become more difficult to recognize the subject in an image, leading to lower recognition precision of the combined region. In addition, image quality of a combined portion after combination processing may deteriorate. The combined region here is a region to be a joint between images when combination processing of a plurality of images is performed.

Even when combination processing is performed by manual operations of a user, it may become more difficult to visually recognize the combined region in an image on which preprocessing has been performed.

### SUMMARY OF THE INVENTION

The present invention is directed to preventing combination processing on a plurality of images being hindered by image processing.

According to an aspect of the present invention, an image processing apparatus to combine a plurality of images, includes an acquisition unit that acquires a combined region when the plurality of images is combined, an image processing unit that performs image processing on at least one of the plurality of images, and a limitation unit that limits the image processing performed on the combined region by the image processing unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram exemplifying a function configuration of a radiation image processing apparatus according to a first exemplary embodiment.

FIG. 2 is a diagram illustrating a flow chart in the first exemplary embodiment.

FIG. 3 is a flow chart illustrating processing when cutout processing is performed.

FIG. 4 is a diagram exemplifying highlighting of regions for combination processing.

FIG. 5 is a diagram exemplifying a warning dialog.

FIG. 6 is a diagram exemplifying the warning dialog.

FIG. 7 is a diagram exemplifying highlighting of regions for combination processing.

### DESCRIPTION OF THE EMBODIMENTS

Various exemplary embodiments, features, and aspects of the invention will be described in detail below with reference to the drawings.

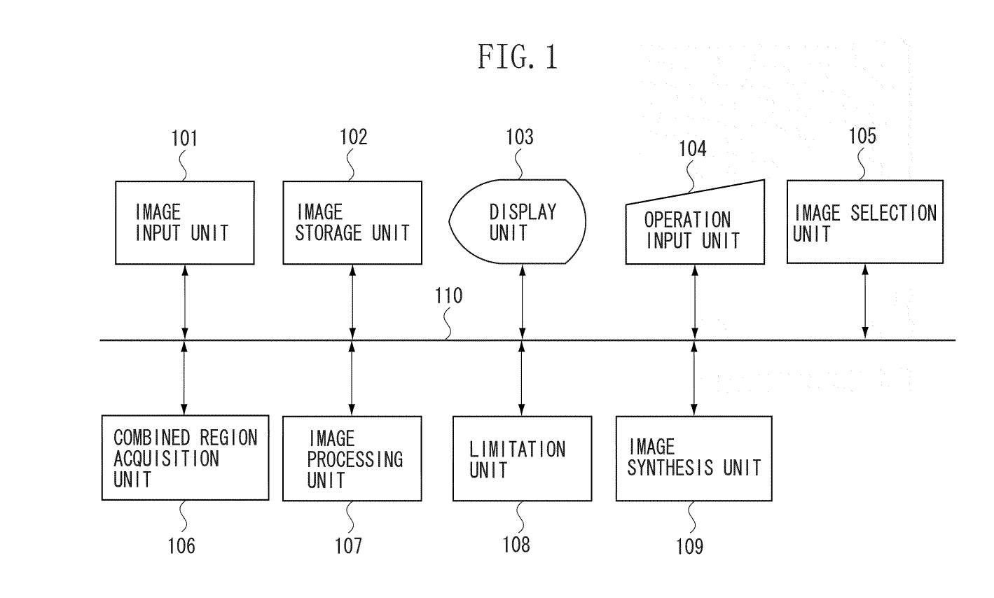

The first exemplary embodiment will be described. FIG. 1 is a block diagram exemplifying the function configuration of a radiation image processing apparatus according to the present exemplary embodiment. A portion of the following function configuration can be replaced by a personal computer having a central processing unit (CPU), random access memory (RAM) in which computer programs are stored and the like.

An image input unit 101 inputs a plurality of radiographic images taken by a digital X-ray imaging machine (radiation imaging apparatus) and photographing information into a radiation image processing apparatus. A network or a recording medium such as a compact disk read only memory (CD-ROM) and a digital versatile disk read only memory (DVD-ROM) may be used as an input method.

An image storage unit 102 stores radiographic images input into the image input unit. The image storage unit 102 includes a recording device to store radiographic images such as a hard disk.

An image display unit 103 displays radiographic images or a region for combination processing. The image display unit 103 includes a display device such as a cathode-ray tube (CRT) monitor and liquid crystal display (LCD) monitor.

An operation input unit 104 inputs instructions such as a cutout operation on a radiographic image displayed in the image display unit 103 and a confirmation operation of warnings. The operation input unit 104 includes a common input device such as a mouse and a keyboard.

An image selection unit 105 selects a plurality of consecutive radiographic images from among radiographic images stored in the image storage unit 102. The image selection unit 105 may select a plurality of radiographic images based on a preset image selection program. Like the operation input unit 104, the image selection unit 105 includes a mouse and a keyboard and may select images based on manual instructions by users.

A combined region acquisition unit 106 acquires a combined region to be a combined portion when the plurality of selected radiographic images is combined. In the present exemplary embodiment, the combined region is a region where, for example, each of a plurality of radiographic images is overlapped. The combined region acquisition unit 106 may identify the combined region by analyzing imaging information contained in a plurality of radiographic images or by performing recognition processing of a subject inside an image on each of the plurality of radiographic images.

An image processing unit 107 performs image processing on the plurality of selected radiographic images. Image processing performed by the image processing unit 107 includes cutout processing, mask processing, and gradation adjustments based on user's instructions.

A limitation unit 108 limits image processing by the image processing unit 107. The limitation unit 108 determines whether a target region of image processing by the image processing unit 107 contains a combined region. If the limitation unit 108 determines that a combined region is contained, the limitation unit 108 limits image processing by the image processing unit 107 so that the image processing is not performed inside the combined region. For example, cutout processing, mask processing, or gradation adjustments for the combined region is disabled. Alternatively, a warning to the user may be issued when image processing on the combined region is instructed.

An image synthesis unit 109 combines a plurality of radiographic images (e.g., two or more images) to synthesize the plurality of radiographic images into one radiographic image.

A system bus 110 interconnects each of the units 101 to 109.

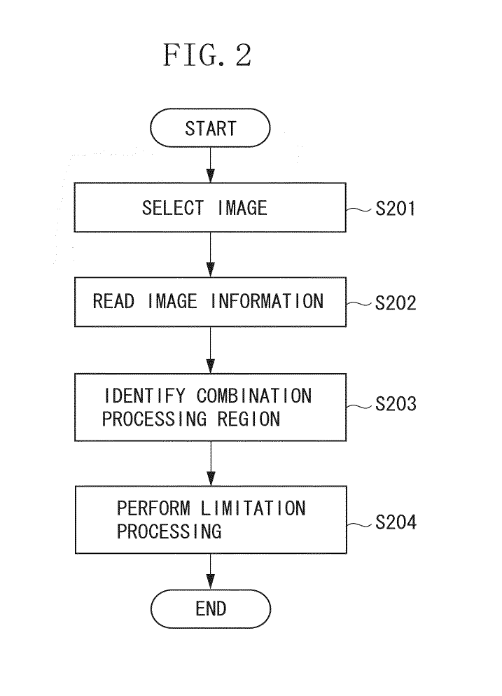

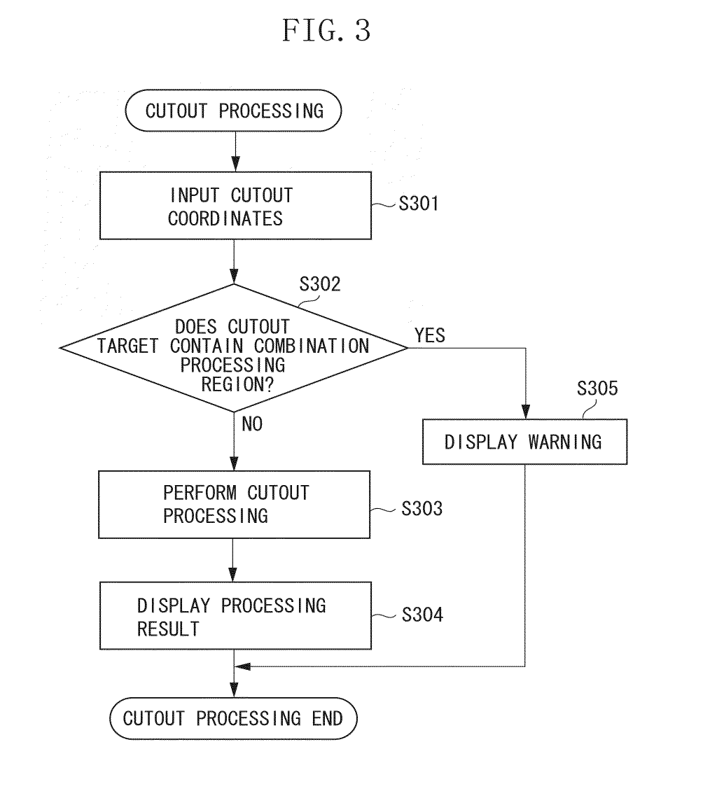

Next, the operation of a radiation image processing apparatus according to the present exemplary embodiment will be described concretely with reference to the flow chart illustrated in FIG. 2. The processing illustrated in FIG. 2 and processing in FIG. 3 described below are processing performed by the image processing unit 107, such as a microprocessor, in collaboration with each component of the above radiation image processing apparatus.

(step S201) In step S201, the image selection unit 105 selects a plurality of consecutive radiographic images from among radiographic images stored in the image storage unit 102.

(step S202) In step S202, the image input unit 101 reads image information. The image information contains position information during imaging (photographing) and thus, a combining region (combined region) of a plurality of images can be determined based on position information, such as coordinate data. The method of determining a combined region is not limited to the identification from coordinate data. For example, a combined region can be identified from a marker included in the images. Specifically, a marker can be added to each image of a plurality of consecutive radiographic images during the imaging process while the radiographic images are being stored in the image storage unit 102.

(step S203) In step S203, the combined region acquisition unit 106 functions as an acquisition unit which acquires a combined region and identifies the combined region of the plurality of images from the read image information. An overlapping region may be determined from position (or orientation) information contained in image information to identify the overlapping region as a combined region. Instead of simply using an overlapping region, a portion of image edges in the overlapping region maybe excluded from a combined region in consideration of the possibility of image quality deterioration.

(step S204) In step S204, the limitation unit 108 functions as a limitation unit which limits image processing and limits image processing on a combined region. As described above, even if image processing is instructed, cutout processing, mask processing, or gradation adjustments for the combined region is disabled. As a warning to the user, a combined region may be highlighted in the image display unit 103.

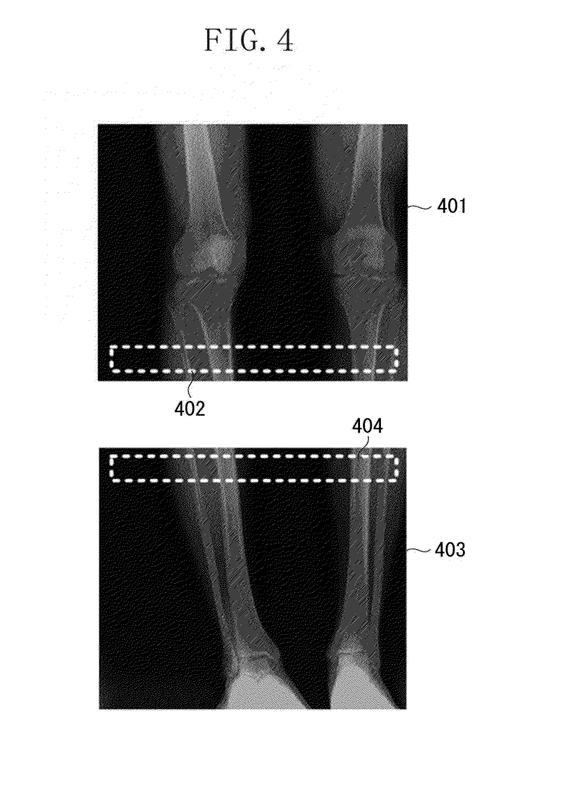

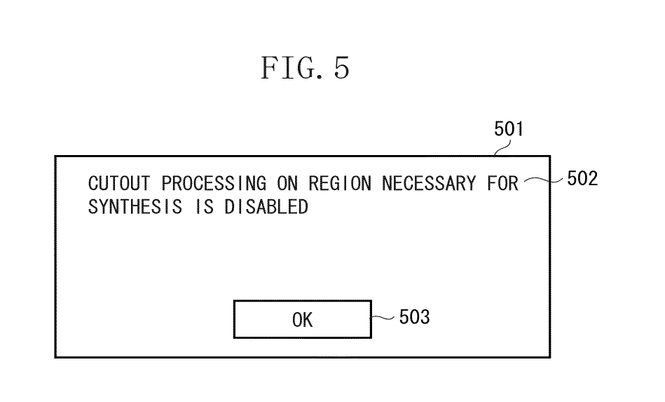

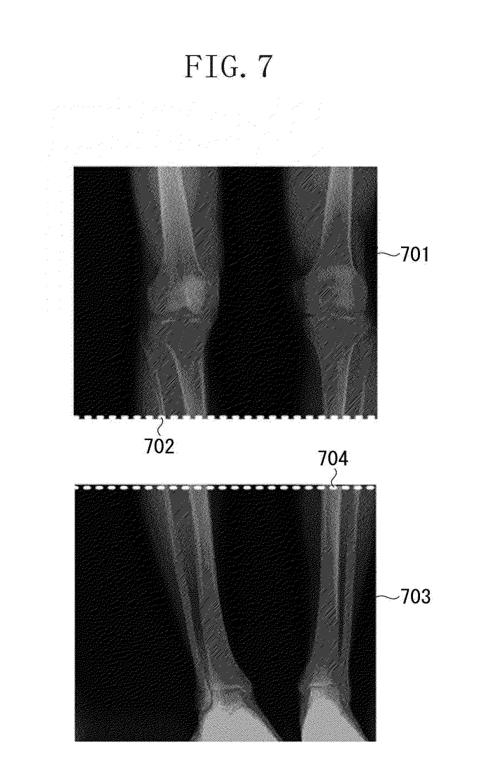

FIG. 4 is a diagram illustrating a display example highlighting regions to be combined (combined regions) in radiographic images. Specifically, in FIG. 4, a combined region 402 in a radiographic image 401 and a combined region 404 in a radiographic image 403 represent a combined region when the images are combined. In FIG. 4, the regions 402, 404 for combination processing are displayed by enclosing the regions with a frame of a broken line. Alternatively, the regions 402, 404 may be enclosed with a translucent frame or filled in with a specific color. As long as the regions 402, 404 for combination processing are highlighted in some manner while displayed the limitation unit can limit (prevent) the image processing performed on the combined region by the image processing unit. Examples of limiting image processing performed on the combined region by the image processing unit is the disabling of a cutout processing as illustrated in FIG. 5, or the issuing of an informative warning as illustrated in FIG. 7. However, limiting the image processing performed on the combined region by the image processing unit is not limited to the above examples. That is, a limitation unit that limits the image processing performed on the combined region by the image processing unit may take into consideration the orientation of the plurality of images, and limit image processing on the combined regions of successive images having the same orientation.

Instead of rectangular regions, as illustrated in FIG. 7, combining boundaries 702, 704 may be highlighted in radiographic images 701, 703 in a broken line. Further, highlighting may have a switching setting for selectively deciding the display/non-display of combining boundaries.

Next, a concrete processing flow of limitation processing in step S204 will be described with reference to the flow chart illustrated in FIG. 3. The processing flow illustrated in FIG. 3 is processing when cutout processing on an image based on user's instructions is performed.

(step S301) In step S301, input of cutout coordinates is acquired from the operation input unit 104 for at least one of a plurality of radiographic images. The cutout operation is performed on at least one of the plurality of radiographic images before combination.

(step S302) In step S302, the limitation unit 108 determines whether input cutout coordinates contain a combined region (overlapping region of a plurality of radiographic images). If the limitation unit 108 determines that input cutout coordinates contain no combined region (NO in step S302), the processing proceeds to step S303. If the limitation unit 108 determines that input cutout coordinates contain a combined region (YES in step S302), the processing proceeds to step S305.

(step S303) In step S303, because cutout coordinates are determined to contain no combined region, the image processing unit 107 functions as an image processing unit and performs normal cutout processing. After the cutout processing, the processing proceeds to step S304.

(step S304) In step S304, because the cutout processing has been performed, the image display unit 103 displays a processing result of the cutout processing.

(step S305) In step S305, because cutout coordinates are determined to contain a combined region, the limitation unit 108 limits the cutout processing in the combined region. In the limitation of the cutout processing, the cutout processing may be completely disabled or may be permitted to a partial region that will not cause any inconvenience for the subsequent combination processing even if the cutout processing is performed thereon. A partial region that will not cause any inconvenience for the combination processing is, for example, a region where pixel values hardly change compared with those outside the combined region (a region where a change of pixel values from those outside the combined region is equal to or less than a predetermined value). In addition to the limitation of cutout processing, a warning notification may be made to the user.

FIG. 5 illustrates an example of the warning display in the present exemplary embodiment. As illustrated in FIG. 5, a message 502 indicating that the processing is disabled and a confirmation button 503 are displayed in a dialog 501.

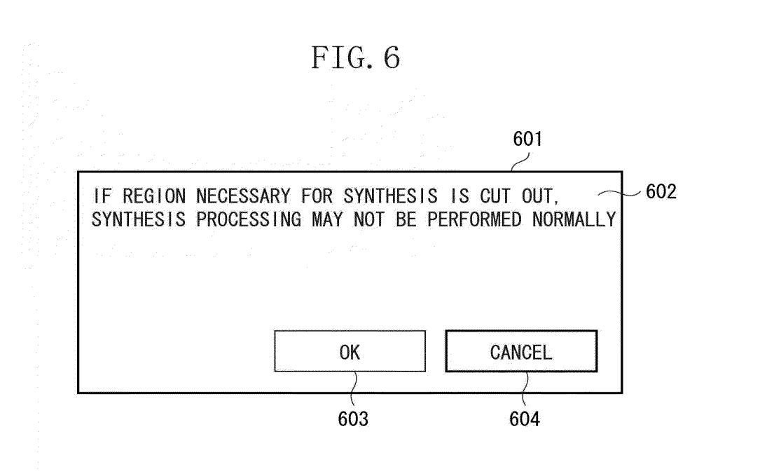

In the present exemplary embodiment, the cutout processing is limited instep S305. However, like a dialog 601 in FIG. 6, display control 602 maybe performed so that a message indicating that combination processing may not be normally performed if the processing is performed is displayed and a confirmation button 603 and a cancel button 604 are displayed to perform the cutout processing. In this case, when the confirmation button is pressed, the processing returns to step S303. Moreover, a warning tone may be usable as a warning method.

The first exemplary embodiment has been described about combination processing on a plurality of radiographic images. However, the present invention is not limited to processing on radiographic images and can also be applied when a panorama image is created from photographed images taken by a common digital camera using visible light for photographing.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-188657 filed Aug. 25, 2010, which is hereby incorporated by reference herein in its entirety.

What is claimed is:

1. An image processing apparatus configured to combine a plurality of images, comprising:
an acquisition unit that acquires a combined region when the images are combined;
an image processing unit that performs image processing on at least one of the plurality of images; and
a limitation unit that limits the image processing performed on the combined region by the image processing unit.

2. The image processing apparatus according to claim 1, wherein the limitation unit issues a notification informing that the image processing on the combined region is limited.

3. The image processing apparatus according to claim 1, wherein the combined region is an overlapping region in the plurality of images.

4. The image processing apparatus according to claim 1, wherein the image processing includes at least one of cutout processing, mask processing, and gradation adjustments for the plurality of images.

5. The image processing apparatus according to claim 1, further comprising: a display control unit that highlights the combined region.

6. The image processing apparatus according to claim 1, wherein, when the image processing is performed on the combined region, the limitation unit issues a notification informing that the combination processing can not be performed normally.

7. The image processing apparatus according to claim 1, wherein, when the image processing includes cutout processing, the limitation unit disables the cutout processing in the combined region.

8. The image processing apparatus according to claim 1, wherein the combined region includes an overlapping region common to at least two consecutive images contained in the plurality of images.

9. An image processing method for combining a plurality of images, comprising:
acquiring a combined region when the plurality of images is combined;
performing image processing on at least one of the plurality of images; and
limiting the image processing on the combined region performed by the image processing unit.

10. A computer readable recording medium in which a computer program is stored, the computer program comprising instructions for:
acquiring a combined region when a plurality of images is combined;
performing image processing on at least one of the plurality of images based on user instructions; and
limiting the image processing on the combined region in the image processing.

11. A computer-readable medium in which a computer program is stored, the computer program comprising computer-executable code for:
acquiring an overlapping region when a plurality of radiographic images is combined;
performing display control to cause a monitor to display the overlapping region and the radiographic images therein;
performing image processing on the plurality of radiographic images; and
limiting the image processing on the overlapping region performed by the image processing.
